(19) United States
(12) Patent Application Publication
(10) Pub. No.: US 2005/0198741 A1
(43) Pub. Date: Sep. 15, 2005

(54) Inflatable support members and structures including the same

(76) Inventors: Adam S. Epstein, Weston, MA (US); Robert W. Pekar, Florence, MA (US)

Correspondence Address: CANTOR COLBURN, LLP, 55 GRIFFIN ROAD SOUTH, BLOOMFIELD, CT, 06002, US

(21) Appl. No.: 11/070,677

(22) Filed: Mar. 2, 2005

Related U.S. Application Data
(60) Provisional application No. 60/549,738, filed on Mar. 2, 2004.

(51) Int. Cl. A61G 7/057

(52) U.S. Cl. 5/689

(57) ABSTRACT

An embodiment of the invention is an inflatable support member having at least one tension point to establish a bend in the inflatable support member. The inflatable support member includes a first sheet and a second sheet sealed around their respective edges. A tension point is formed by enlarging the seam area where a bend in the inflatable support member is desired. Alternate embodiments of the invention include structures including the inflatable support member. An alternate inflatable support member includes a first sheet and second sheet, the second sheet having an elasticity less than that of the first sheet by using different materials, additional materials or stretching the second sheet.

### CROSS-REFERENCE TO RELATED APPLICATIONS

This application claims the benefit of U.S. provisional patent application Ser. No. 60/549,738, filed Mar. 2, 2004, the entire contents of which are incorporated herein by reference.

### BACKGROUND

This invention relates to inflatable support members and structures including inflatable support members. Currently, inflatable support members are used in structures such as tents. The inflatable support member often includes bends where the support member changes direction to establish the desired shape of a structure. Conventional inflatable support members, and the structures created from these support structures, often employ complex mechanisms to form and maintain bends in the inflatable support member.

### SUMMARY OF THE INVENTION

An embodiment of the invention is an inflatable support member having at least one tension point to establish a bend in the inflatable support member. The inflatable support member includes a first sheet and a second sheet sealed around their respective edges. A tension point is formed by enlarging the seam area where a bend in the inflatable support member is desired. Alternate embodiments of the invention include structures including the inflatable support member. An alternate inflatable support member includes a first sheet and second sheet, the second sheet having an elasticity less than that of the first sheet by using different materials, additional materials or stretching the second sheet.

### BRIEF DESCRIPTION OF THE DRAWINGS

In the drawings, in which like reference numerals indicate corresponding parts in all views:

FIG. 1 is a top view of an inflatable support member;

FIG. 2 is an exemplary structure including inflatable support members;

FIG. 3 is a side view of an inflatable support member in an alternate embodiment;

FIG. 4 is a top view of the inflatable support member of FIG. 3;

FIG. 5 is an exploded view of an inflatable support member in another embodiment; and

FIG. 6 depicts the inflatable support member of FIG. 5 inflated.

### DESCRIPTION OF THE PREFERRED EMBODIMENTS

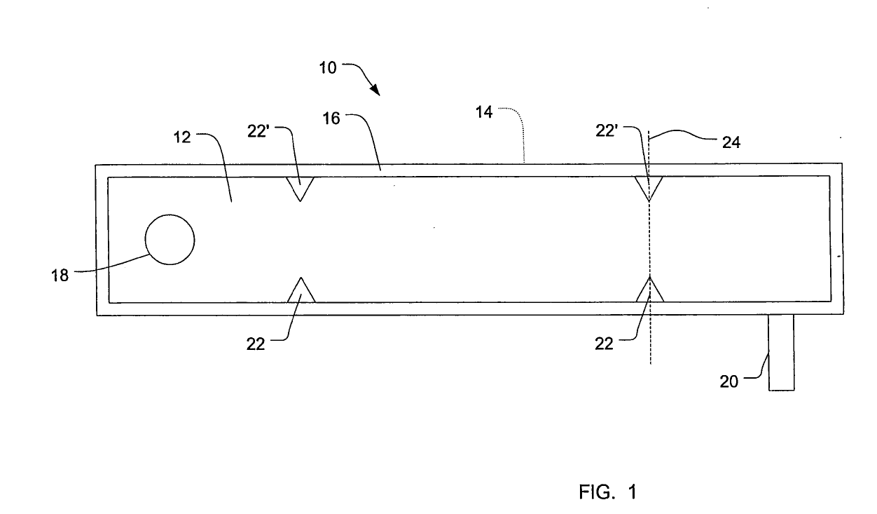

FIG. 1 is a top view of an inflatable support member 10 in an exemplary embodiment of the invention. The inflatable support member 10 includes a first sheet 12 and a second sheet 14 joined along the edges at a seam 16. The first sheet 12 and second sheet 14 may be made from a plastic, thermoplastic or woven/non-woven material laminated with thermoplastic, etc. Seam 16 joining the two sheets may be formed by applying energy through heat pressing, RF welding, ultrasonic welding, impulse welding, etc. The sealed sheets 12 and 14 form an inflatable chamber. A one way inlet 20 may be used to inflate the inflatable support member 10 and an outlet valve 18 may be used to release fluid (e.g., air) from the inflatable support member 10. It is understood that a two-way valve may be used to provide inflation and deflation of the inflatable support member 10.

The inflatable support member 10 includes tension points 22 and 22′ which are formed by expanding the seam 16 inwards towards a central, longitudinal axis of the inflatable support member 10. The tension points 22 and 22′ are preferably formed when seam 16 is formed by applying energy to tension points 22 and 22′ to seal the first sheet 12 and the second sheet 14 at tension points 22 and 22′. Tension points 22 and 22′ are provided on opposite edges of the inflatable support member 10 and serve to constrict the inflatable support member 10 upon inflation by forming an area of reduced cross section along line 24. This tension forms a bend region along line 24. The tension points 22 and 22′ may be located at multiple locations along the inflatable support member 10 to control the shape of the inflatable support member 10 upon inflation. The tension points in FIG. 1 are shown as triangular but these points may be formed using any geometry.

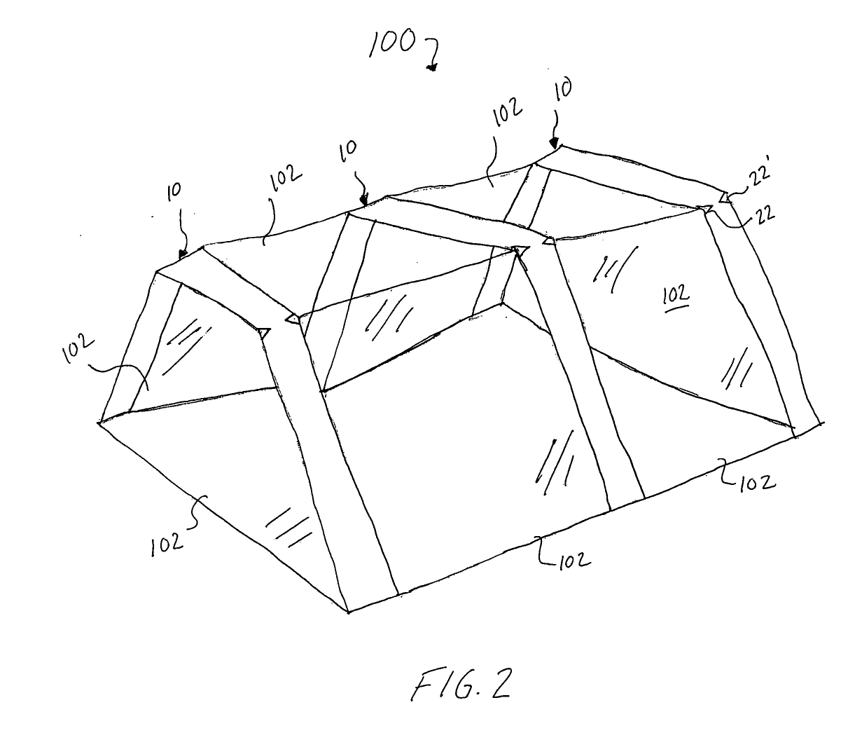

FIG. 2 is a perspective view of an exemplary structure 100 formed using a plurality of the inflatable support members 10. As shown in FIG. 2, the inflatable support members 10 include bends located at the bend line 24 co-linear with the tension points 22 and 22′. Panels of thermoplastic material 102 are secured to the inflatable support members 10 by joining seam 16 to the panels 102 by applying energy (heat, RF welding, ultrasonic welding). Of course, an entire panel 102 or an edge of a panel may be left unsealed to provide for entry into structure 100. The panels 102 may be transparent thermoplastic or other material. The structure may be of suitable size to contain a person to isolate the person from hazards or isolate others from the person (e.g., contagious disease).

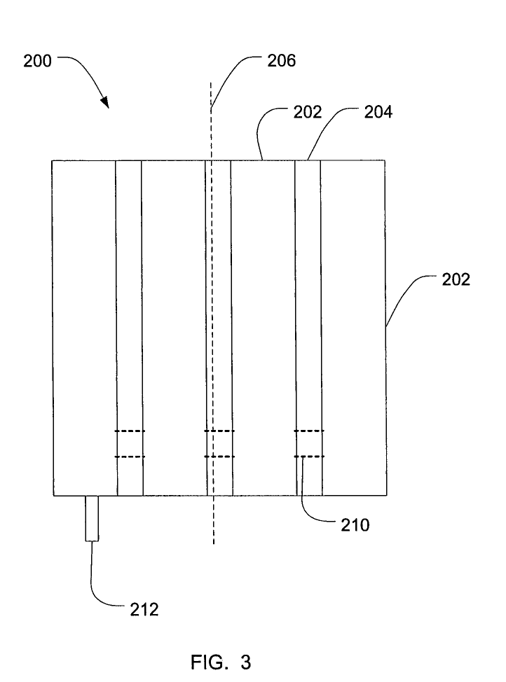

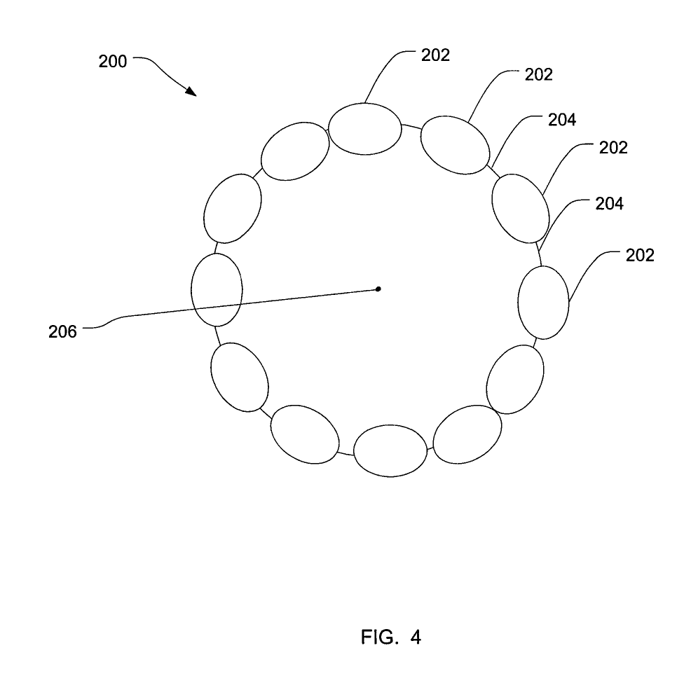

FIG. 3 is a side view and FIG. 4 is a top view of an inflatable support member 200 in an alternate embodiment of the invention. Inflatable support member 200 includes a plurality of inflatable chambers 202 joined at seams 204. Chambers 202 are joined in a continuous fashion to define a closed structure as shown in FIG. 4. The chambers 202 and seams 204 may be formed by joining sheets of thermoplastic material (e.g., heat pressing, RF welding, ultrasonic welding).

The chambers 202 may be inflated with any fluid (e.g., air, water, gel, compressed gas) through a common inlet 212. Inter-chamber channels 210 provide fluid communication between chambers 202. The inter-chamber channels 210 may be formed by applying a release coating to the thermoplastic sheets prior to joining the sheets. The release coating prevents adhesion of the sheets and defines inter-channel chambers 210. Alternatively, the inter-chamber channels 210 may be formed using a heat press having a pattern such that the thermoplastic sheets are not joined at the areas corresponding to inter-channel chambers 210.

In the embodiment shown in FIGS. 3 and 4, the chambers 202 are arranged in a circle about a longitudinal axis 206. It is understood that chambers 202 may be arranged in different shapes such a squares, ovals, ellipses, etc. The arrangement of the chambers around axis 206 provides inflatable support member 200 with substantial strength along the longitudinal axis 206, and significantly less strength along a lateral axis perpendicular to axis 206. This renders inflatable support member 200 useful in applications where lightweight, structural support is needed.

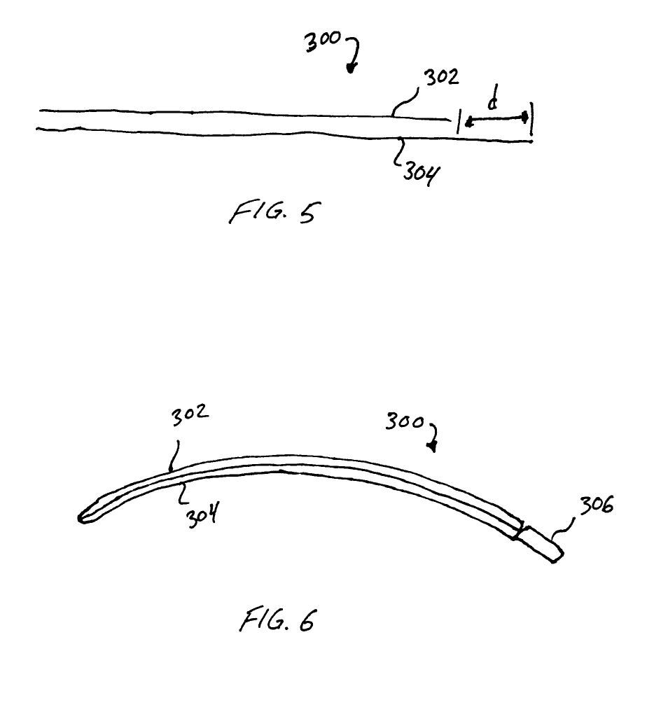

FIGS. 5 and 6 depict another technique for producing an inflatable support member 300 with an arcuate shape to facilitate forming structures. The inflatable support member 300 includes two sheets of material 302 and 304. In an exemplary embodiment, the sheets 302 and 304 are thermoplastic or other plastic and/or woven/non-woven materials and are joined along their periphery (e.g., heat sealed, ultrasonically welded) to define an inflatable chamber. Sheet 304 has an elasticity less than that of sheet 302. The elasticity of sheet 304 may be adjusted by pre-tensioning or stretching sheet 304 prior to sealing sheet 304 to sheet 302. As shown in FIG. 5, sheet 304 is stretched by a distance d. Alternatively, sheet 304 may be made from a material having an elasticity less than that of sheet 302. Alternate methods may be used to provide different elasticity to sheet 304 including using materials with different durometers (second sheet has higher durometer than first sheet), using laminated materials, applying scrims to one or both of the first and second sheet, using oriented material with different stretch characteristics in different directions, etc.

When assembled, a pump 306 is placed in fluid communication with the chamber defined by sheets 302 and 304. Pump 306 is coupled to an inlet valve (e.g., one-way check valve) to the chamber defined by sheets 302 and 304. When inflated, the lower elasticity of sheet 304 allows sheet 302 to expand more than sheet 304 thereby creating an arcuate inflated support member.

The use of sheets having different elasticity as shown in FIGS. 5 and 6 may be used alone or in combination with the tension points shown discussed with reference to FIGS. 1 and 2 to control the shape of the inflatable support member upon inflation.

Multiple inflatable support members may be coupled to define a support beam. The individual inflatable support members 10 or 300 may be joined end-to-end using a variety of sealing techniques such as heat sealing, ultrasonic welding, heat pressing, or impulse welding.

It is to be understood the preferred embodiments of this invention herein disclosed and illustrated are by way of illustration, and not limitation, and that changes and modifications can be made without departing from the spirit or scope of this invention.

1. An inflatable support member comprising:
a first sheet;
a second sheet joined to said first sheet along a seam, said first sheet and said second sheet defining an inflatable chamber;
an inlet valve for allowing fluid to enter said inflatable chamber; and
a pair of tension points formed on said seam, said tension points extending from said seam towards a central, longitudinal axis of said inflatable structure, said tension points establishing a bend line when the inflatable support member is inflated.

2. The inflatable support member of claim 1 wherein:
said first sheet and said second sheet are selected from the group comprising plastic, thermoplastic, woven material laminated with thermoplastic or non-woven material laminated with thermoplastic.

3. The inflatable support member of claim 2 wherein:
said first sheet and said second sheet are joined by one of heat sealing, ultrasonic welding, heat pressing, or impulse welding.

4. The inflatable support member of claim 1 wherein:
said tension points are formed by applying energy to said first sheet and said second sheet on opposite sides of said central, longitudinal axis.

5. The inflatable support member of claim 1 wherein:
said second sheet having an elasticity less than that of the first sheet, said inflatable support member having an arcuate shape upon inflation.

6. The inflatable support member of claim 5 wherein:
said second sheet is stretched prior to sealing said first sheet to said second sheet.

7. The inflatable support member of claim 5 wherein:
said second sheet is made from a material having an elasticity less than that of the first sheet.

8. The inflatable support member of claim 5 wherein:
said second sheet is made from a material having a durometer higher than that of the first sheet.

9. An inflatable support member comprising:
a first sheet;
a second sheet joined to said first sheet along a seam, said first sheet and said second sheet defining an inflatable chamber;
an inlet valve for allowing fluid to enter said inflatable chamber;
said second sheet having an elasticity less than that of the first sheet, said inflatable support member having an arcuate shape upon inflation.

10. The inflatable support member of claim 9 wherein:
said second sheet is stretched prior to sealing said first sheet to said second sheet.

11. The inflatable support member of claim 9 wherein:
said second sheet is made from a material having an elasticity less than that of the first sheet.

12. The inflatable support member of claim 9 wherein:
said second sheet is made from a material having a durometer higher than that of the first sheet.

13. The inflatable support member of claim 9 further comprising:
a further inflatable support member joined to said inflatable support member; the further inflatable support member including:
a first sheet;
a second sheet joined to said first sheet along a seam, said first sheet and said second sheet defining an inflatable chamber;
an inlet valve for allowing fluid to enter said inflatable chamber;
said second sheet having an elasticity less than that of the first sheet, said inflatable support member having an arcuate shape upon inflation.

14. A structure comprising:
at least one panel of material;
at least one inflatable support member joined to said panel; said inflatable support member including:
a first sheet;
a second sheet joined to said first sheet along a seam, said first sheet and said second sheet defining an inflatable structure;
an inlet valve for allowing fluid to enter said inflatable structure; and,
a pair of tension points formed on said seam, said tension points extending from said seam towards a central, longitudinal axis of said inflatable structure, said tension points establishing a bend line when the inflatable structure is inflated.
